(19) United States
(12) Patent Application Publication
(10) Pub. No.: US 2024/0209146 A1
(43) Pub. Date: Jun. 27, 2024

(54) PROCESS FOR PRODUCING POLYCARBONATE WITH IMPROVED SUSTAINABILITY

(71) Applicant: Covestro Deutschland AG, Leverkusen (DE)

(72) Inventors: Andreas Bulan, Langenfeld (DE); Jan Heijl, Evergem (BE); Rainer Weber, Odenthal (DE)

(21) Appl. No.: 18/288,112

(22) PCT Filed: Apr. 27, 2022
(86) PCT No.: PCT/EP2022/061161

§ 371 Date: Oct. 24, 2023

(30) Foreign Application Priority Data
Apr. 30, 2021 (EP) 21171470.4

(51) Int. Cl. C08G 64/24; B01D 53/02; B01D 53/14; B01D 53/26; B01J 19/24; C08G 64/06; C08G 64/20; C25B 1/46; C25B 15/08

(52) U.S. Cl. CPC C08G 64/24; B01D 53/02; B01D 53/1475; B01D 53/265; B01J 19/245; B01J 19/2465; C08G 64/06; C08G 64/205; C25B 1/46; C25B 15/081; B01D 2252/204; B01D 2256/22; B01D 2257/108; B01D 2257/504; B01D 2257/80

(57) ABSTRACT

A process, and a device system suitable therefore, for producing polycarbonates are provided. The process contains the steps of producing at least chlorine and hydrogen by the chloralkali electrolysis of alkali chloride, preferably sodium chloride, in aqueous solution; synthesizing phosgene from carbon monoxide and chlorine; reacting phosgene with diol to form polycarbonate; providing a cleaned carbon dioxide gas stream as a process product of a process containing the steps of providing a CO2 gas stream and purifying the carbon dioxide gas stream by removing secondary constituents; converting the purified carbon dioxide into carbon monoxide and hydrogen by means of an RWGS reaction, which carbon monoxide and hydrogen can be used as raw materials for the polycarbonate production.

### CROSS REFERENCE TO RELATED APPLICATIONS

This application is a U.S. national stage application, filed under 35 U.S.C. § 371, of International Application No. PCT/EP2022/061161, which was filed on Apr. 27, 2022, and which claims priority to European Patent Application No. 21171470.4, which was filed on Apr. 30, 2021. The contents of each are hereby incorporated by reference into this specification.

### FIELD

The invention relates to a process for producing polycarbonate (polycarbonate hereinbelow also referred to as PC) by synthesizing phosgene from carbon monoxide and chlorine, reacting phosgene with at least one diol, in particular diaryl alcohol, to afford polycarbonate, providing a carbon dioxide gas stream and purifying the carbon dioxide gas stream of secondary constituents and subsequently reacting the carbon dioxide to produce carbon monoxide which is employed in the phosgene synthesis.

The invention further relates to an embodiment which comprises recovering polycarbonate compounds of a polycarbonate material present in waste (hereinbelow also referred to as “polycarbonate material waste”) to produce chemical raw materials for producing polycarbonate, wherein carbon dioxide and hydrocarbons and optionally carbon monoxide and hydrogen are produced from polycarbonate material waste, for example by pyrolysis, the carbon dioxide is converted by reaction with hydrogen into carbon monoxide in a so-called reverse water gas shift reaction (hereinafter RWGS reaction) and the obtained carbon monoxide is converted into polycarbonate via phosgene.

The invention especially relates to a process for low-emission production of polycarbonate using an RWGS reaction and provision of hydrogen from a water electrolysis or from an electrolysis to produce chlorine and utilization of the oxygen from the water electrolysis for incineration of polycarbonate-containing materials to afford carbon dioxide and optionally incineration of pyrolysis residues obtained from polycarbonate-containing materials and use of the carbon dioxide obtained in each case as raw material for the RWGS reaction.

### BACKGROUND

One approach for materials recycling of polycarbonate is alcoholysis, wherein the carbonate group of the polymer is reacted with an alcohol to afford dialkyl or diaryl carbonate and a diol. This method has the disadvantage that it requires a virtually pure polycarbonate as a starting material, i.e. the abovementioned blends are largely unsuitable as starting material therefor.

It was an object of the present invention to find a more sustainable process for polycarbonate production by including recycling processes and closing the value chains. Essential components for polycarbonate production such as carbon monoxide, hydrogen or the electricity for operating the electrolyses such as the water electrolysis and the chloralkali electrolysis have hitherto been produced from fossil fuels. For example, carbon monoxide and hydrogen are conventionally obtained from natural gas or coal by means of reforming processes, and chlorine is obtained from electrolysis with electricity produced using fossil fuels such as oil, coal or natural gas.

The “sustainability” of a process is understood by those skilled in the art according to the definition of sustainability (sustainable development) coined by the UN in the Brundtland Report of the “World Commission on Environment and Development”, this being that the execution of the process in the present makes the smallest possible contribution, or none at all, to compromising the ability of future generations to meet their own needs, in particular needs in respect of the use of resources such as fossil raw materials and especially in respect of the conservation of living space, for example the protection of the earth's atmosphere. It is thus an object of the invention to make the production of polycarbonate more sustainable than the production methods known from the prior art. The contribution of polycarbonate production to a decreasing ability to meet the needs of future generations should be reduced or even avoided.

### SUMMARY

It is accordingly an object of the invention to reduce the use of fossil feedstocks as a reactant for polycarbonate production and optionally also the use of fossil feedstocks for providing energy for polycarbonate production. The latter object in particular is intended to further improve the carbon footprint of polycarbonate production to protect Earth's atmosphere.

The invention accordingly provides a process for producing polycarbonate comprising at least the steps of
producing at least chlorine and hydrogen by chloralkali electrolysis of alkali metal chloride, preferably sodium chloride, in aqueous solution,
providing a purified CO₂ gas stream produced by at least the steps of:
   providing a CO₂ gas stream,
   purifying the CO₂ gas stream of secondary components (in particular nitrogen oxides, sulfur compounds, phosphorus compounds, dust, water, oxygen and HCl) optionally by adsorption, gas scrubbing or catalytic treatment to obtain a gas stream of purified carbon dioxide,
introducing hydrogen together with the purified CO₂ gas stream into an RWGS reaction zone and reacting the reactants according to the principle of RWGS to afford a product gas mixture containing not only unconverted reactant but also steam, CO and optionally byproducts, in particular lower hydrocarbons, especially preferably methane,
separating the water of the steam from the product gas mixture,
separating unconverted carbon dioxide from the gas mixture of the RWGS reaction obtained from the separation, in particular by amine scrubbing, and recycling the unconverted carbon dioxide into the RWGS reaction,
separating the hydrogen unconverted in the RWGS reaction from the gas mixture of carbon monoxide and hydrogen obtained after the separation, in particular using a coldbox, and recycling the hydrogen into the RWGS reaction,
introducing the remaining carbon monoxide from the separation into the phosgene synthesis,
supplying the previously formed chlorine (22) into the phosgene synthesis,
synthesizing phosgene from carbon monoxide and chlorine,
reacting at least phosgene with at least one diol to afford at least one polycarbonate.

### BRIEF DESCRIPTION OF DRAWINGS

FIG. 1 shows a schematic overview of the overall process comprising the RWGS reaction, chlorine production, PC production, use, and recovery of the polycarbonate material waste therefrom to afford CO₂ for the RWGS reaction

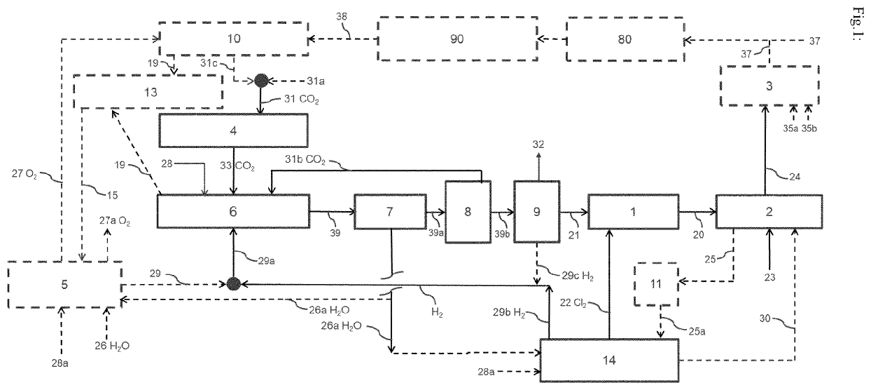

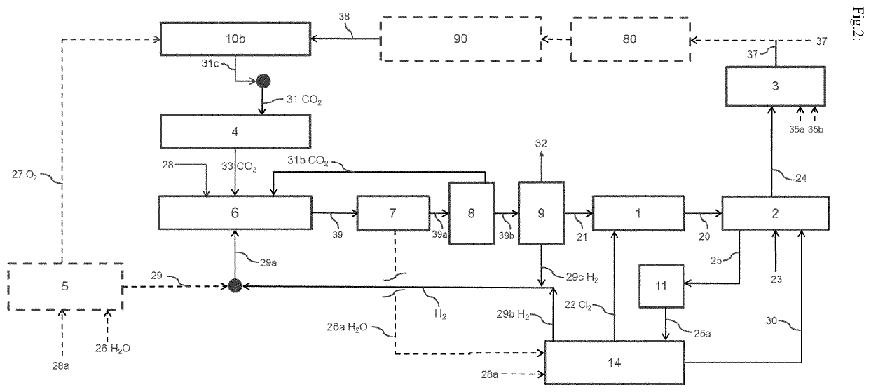

FIG. 1 shows a process for producing polycarbonate comprising at least the steps of
producing at least chlorine 22 and hydrogen 29b by chloralkali electrolysis 14 of alkali metal chloride, preferably sodium chloride, in aqueous solution,
providing a purified CO₂ gas stream 33 produced by a method containing at least the steps of:
   providing a CO₂ gas stream 31
   purifying 4 the CO₂ gas stream 31 of secondary components (in particular of nitrogen oxides, sulfur compounds, dust, water, oxygen and HCl) optionally by adsorption, gas scrubbing or catalytic treatment to obtain a gas stream of purified carbon dioxide 33,
introducing hydrogen 29a together with the purified CO₂ gas stream 33 into an RWGS reaction zone and reaction 6 of the reactants according to the principle of RWGS to afford a product gas mixture 39 containing not only unconverted reactant but also steam 26b, CO 21 and optionally byproducts 32, in particular lower hydrocarbons, especially preferably methane,
separating 7 the water of the steam 26b from the product gas mixture 39,
separating 8 unconverted carbon dioxide 31b from the gas mixture 39a of the RWGS reaction 6 obtained from the separation 7, in particular by amine scrubbing, and recycling the unconverted carbon dioxide 31b into the RWGS reaction 6,
separating 9 the hydrogen unconverted in the RWGS reaction 6 from the gas mixture 39b of carbon monoxide and hydrogen obtained after the separation 8, in particular using a coldbox, and recycling the separated hydrogen 29c into the RWGS reaction 6,
introducing the remaining carbon monoxide 21 from the separation 9 into the phosgene synthesis 1,
supplying the previously formed chlorine 22 into the phosgene synthesis 1,
synthesizing 1 phosgene 20 from carbon monoxide 21 and chlorine 22, reacting 2 at least phosgene 20 with at least one diol 23 to afford at least one polycarbonate 24.

It is preferable when according to FIG. 1 the RWGS synthesis 6 employs purified carbon dioxide 33 which is provided from the recovery 10 of polycarbonate material waste 38 by incineration 10b and/or by pyrolysis 10a as carbon dioxide 31a and is purified in the purification 4.

It is in turn preferable when according to the process of FIG. 1 as recovery 10 an incineration 10b using gas having an oxygen gas content (O₂) of at least 30% by volume can be performed, in particular using oxygen gas 27a which is obtained from a water electrolysis 5. In a preferred embodiment the water electrolysis 5 is performed using electricity 28a generated from renewable energy, in particular from renewable energy in the form of wind power, solar power or hydro power. Heat energy 19 for energy and steam production 13 may be diverted from the recovery 10 and the RWGS reaction 6, wherein the water electrolysis 5 may additionally be operated with electricity 15 generated in the energy production 13.

According to FIG. 1 the RWGS reaction 6 is supplied with heat energy which is either produced by means of electricity 28 generated from renewable energy, in particular electricity obtained using wind power, solar power or hydro power as desired. The heating of the RWGS reaction 6 is further effected by burning of hydrocarbons from renewable sources, in particular by burning of biomethane.

According to the process illustrated in FIG. 1 preferred provision of the CO₂ gas stream 31 preferably comprises employing polycarbonate material 37 after use 80 thereof to obtain end-of-life products containing polycarbonate material 37 and subsequently recycling the polycarbonate material waste 38 obtained from the recycling 90 of the end-of-life products and incinerating said material to afford carbon dioxide 31c, wherein the carbon dioxide 31c is sent for purification 4 as input material 31 (closed-loop recycling). It is likewise possible according to FIG. 10 to also employ for recovery 10 polycarbonate material waste 38 deriving from polycarbonate material 37 not produced by the process according to the invention.

Furthermore, it is preferable when in the process depicted in FIG. 1, in the reaction 2 of at least phosgene 20 with at least one diol 23, not only at least one polycarbonate but also alkali metal chloride in solution 25 is formed and this solution is subjected to a separation and purification 11, wherein said separated and purified alkali metal chloride 25a present in aqueous solution is supplied to the chloralkali electrolysis 14.

In the process of FIG. 1 the chloralkali electrolysis 14 is preferably performed using electricity 28a generated from renewable energy, in particular electricity 28a obtained through the use of wind power, solar power or hydro power as desired.

FIG. 1 additionally shows an embodiment of the process in which the reaction 2 of at least phosgene 20 with at least one diol 23 to afford at least one polycarbonate 24 is additionally supplied with alkali metal hydroxide solution 30 obtained from the chloralkali electrolysis 14.

According to the process of FIG. 1 the polycarbonate 24 obtained from the reaction 2 may be converted into polycarbonate material 37 preferably in the compounding 3 by addition of colorants or further additives 35a and at least one further polymer as a blend partner 35b (for example polystyrene copolymer).

In FIG. 1, the following reference numerals are defined on the right-hand side as follows:
1 Phosgene synthesis
2 Polycarbonate production
3 Compounding to produce polycarbonate material 37
4 CO₂ gas purification
5 Water electrolysis
6 RWGS reaction (reverse water gas shift reaction)
7 Water separation
8 CO₂ separation
9 H₂—CO separation
10 Recovery of polycarbonate material waste 38 by pyrolysis (10a) and/or incineration (10b)
10a Pyrolysis
10b Incineration
11 Workup of NaCl from wastewater 25
13 Energy and steam generation
14 Chloralkali electrolysis to produce Cl₂ and H₂ and preferably alkali metal hydroxide solution
15 Electricity from energy/steam (13)
19 Heat
20 Phosgene from phosgene synthesis 1
21 Separated carbon monoxide from the H₂—CO separation 9
22 Chlorine gas
23 Diol (for example bisphenol A)
24 Polycarbonate
25 Alkali metal chloride-containing wastewater, in particular NaCl-containing wastewater
25a Worked-up alkali metal chloride-containing wastewater, in particular worked-up sodium chloride-containing wastewater
26 Water
26a Separated water from product gas mixture 39 of the RWGS reaction
27 Oxygen from water electrolysis
27a Oxygen from water electrolysis for other uses
28 Bio-natural gas and/or renewable energy only for heating
28a Electricity from renewable energy
29 Hydrogen from water electrolysis
29a Hydrogen for the RWGS reaction
29b Hydrogen from the chloralkali electrolysis 14
29c Separated hydrogen from the H₂—CO separation
30 Aqueous solution of alkali metal hydroxide, preferably sodium hydroxide
31 CO₂ for supplying to CO₂ gas purification 4
31a CO₂ from renewable source
31b Unconverted CO₂ from CO₂ separation
31c CO₂ from 10
32 Separated byproducts from the RWGS reaction
33 Purified CO₂
35a Colorant or other additives
35b Polymer as a blend partner (for example polystyrene copolymer)
37 Polycarbonate material
38 Polycarbonate material-containing waste (polycarbonate material waste) for 10
39 Product gas mixture from the RWGS reaction consisting of carbon monoxide, water, CO₂, hydrogen and byproducts
39a 39 with reduced water content
39b 39a with decreased content of CO₂
80 Commercial use of 37
90 Polycarbonate-based materials—end-of-life recycling

Arrows in the figure symbolize the flow of substances, energy or heat between process steps/through a fluid connection provided for this purpose between apparatus parts in which the corresponding process steps are performed. Dashed lines in the figures denote parts of preferred embodiments of individual above-described features of the process. A filled circle represents a node of a material flow.

FIG. 2 shows a schematic overview of the process described in example 1 comprising the RWGS reaction, a chloralkali electrolysis including PC production, use of the polycarbonate material and recovery of the polycarbonate material waste therefrom to afford CO₂ for the RWGS reaction.

The assignment of the reference numbers used in FIG. 2 is as defined for FIG. 1.

### DETAILED DESCRIPTION

“Lower hydrocarbons” are in accordance with the invention understood as meaning hydrocarbons having 1 to 8 carbon atoms.

“Amine scrubbing” of the product gas of the RWGS reaction is here understood as meaning in particular as the generally known scrubbing of the gas mixture according to the principle of chemisorption with amines such as monoethanolamine (MEA), diethanolamine (DEA), methyldiethanolamine (MDEA) or diglycolamine (DGA), which even at relatively low pressure in an absorption column achieves a high purity of the purified gas mixture.

“Renewable energy” is understood by those skilled in the art as meaning energy from an energy source that does not become exhausted, such as wind energy, hydro energy or solar energy.

Provision of carbon monoxide for the synthesis of the phosgene requires a carbon dioxide gas stream which is purified and introduced into the RWGS reaction. The carbon monoxide preferably produced from the recovery of the polycarbonate material waste is reacted with chlorine to afford phosgene and this is reacted with diol, in particular diaryl alcohol, to afford polycarbonate. This closes a section of the value chain. The use of CO₂ and electricity from renewable energy sources for the optional water electrolysis makes it possible to produce polycarbonate with further improved sustainability. The proportion of fossil carbon in the polycarbonate is to be markedly reduced.

It will now be described by way of example how the polycarbonate compound of the polycarbonate material waste employed for the recovery and the polycarbonate produced according to the present process are producible.

Production may be carried out for example by the known interfacial process as described for example in Schnell, “Chemistry and Physics of Polycarbonates”, Polymer Reviews, Volume 9, Interscience Publishers, New York, London, Sydney 1964, pages 33-70: Freitag et al., BAYER AG, “Polycarbonates” in Encyclopedia of Polymer Science and Engineering, Volume 11, Second Edition, 1988, pages 651-692.

To produce polycarbonate by the interfacial process a disodium salt of a diphenol initially charged in aqueous alkaline solution or suspension or a mixture of two or more different diphenols initially charged in aqueous alkaline solution or suspension is reacted in the presence of an inert organic solvent or solvent mixture with a carbonyl halide, in particular phosgene, wherein the inert organic solvent/solvent mixture forms a second organic phase in addition to the aqueous phase. The resulting oligocarbonates primarily present in the organic phase are subjected to condensation with the aid of suitable catalysts to afford high molecular weight polycarbonates dissolved in the organic phase, wherein the molecular weight may be controlled by suitable chain terminators, for example monofunctional phenols such as phenol or alkylphenols, in particular phenol, p-tert-butylphenol, isooctylphenol or cumylphenol. The organic phase is finally separated and the polycarbonate is isolated therefrom by various workup steps. For bisphenol A for example the reactions may be represented as follows:

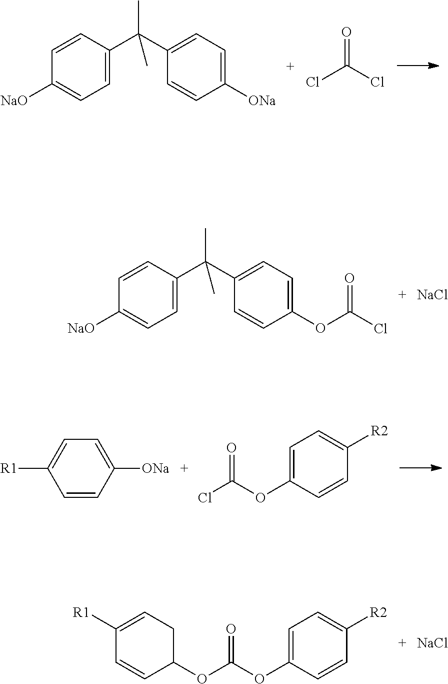

wherein R1 and R2 may independently of one another represent growing polycarbonate chains or chain terminators.

It is therefore advantageous in the context of a preferred embodiment of the process when the reaction of at least phosgene with at least one diol to afford at least one polycarbonate additionally has alkali metal hydroxide solution (in particular aqueous sodium hydroxide solution) supplied to it which is particularly preferably at least partially formed by the operation of the chloralkali electrolysis.

Continuous processes for producing condensates using carbonyl halides, in particular phosgene,—for example the production of aromatic polycarbonates or polyestercarbonates or oligomers thereof—by the two-phase interfacial process generally have the disadvantage that acceleration of the reaction and/or improving the phase separation requires more phosgene to be employed than is necessary for the product balance. The phosgene excess is then decomposed in the synthesis in the form of byproducts—for example additional common salt or alkali metal carbonate compounds. The continuous two-phase interfacial process for producing aromatic polycarbonates typically employs phosgene excesses of around 20 mol % based on the added diphenoxide.

In the context of the present invention in a preferred embodiment a polycarbonate and a polycarbonate compound are to be understood as meaning a polymeric compound selected from a homo- or copolymer, wherein at least
one repeating unit contains at least one

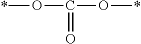

structural unit,
where * denotes a valence of the polymer backbone.

The term polycarbonate and polycarbonate compound in the context of the present invention comprises compounds which may be homopolycarbonates, copolycarbonates and/or polyestercarbonates: the polycarbonates may be linear or branched in known fashion. It is also possible according to the invention to employ mixtures of polycarbonates.

Suitable polycarbonate compounds of the polycarbonate material and suitable polycarbonates likewise include thermoplastic polycarbonates including the thermoplastic aromatic polyestercarbonates. These preferably have average molecular weights Mw (determined by measuring relative solution viscosity at 25° C. in CH₂Cl₂ and a concentration of 0.5 g per 100 ml of CH₂Cl₂) of 18 000 g/mol to 36 000 g/mol, preferably of 23 000 g/mol to 31 000 g/mol, in particular of 24 000 g/mol to 31 000 g/mol.

A portion of up to 80 mol %, preferably of 20 mol % to 50 mol %, of the carbonate groups in the polycarbonate compounds employed according to the invention and the polycarbonates produced may be replaced by aromatic dicarboxylic ester groups. Such polycarbonates and polycarbonate compounds which include both acid radicals of carbonic acid and acid radicals of aromatic dicarboxylic acids incorporated in the molecular chain are referred to as aromatic polyestercarbonates. In the context of the present invention they are subsumed by the umbrella term “thermoplastic aromatic polycarbonates”.

Production of the polycarbonates/the polycarbonate compounds of the polycarbonate material is carried out in known fashion from at least one diphenol (diphenol is hereinbelow also referred to as dihydroxyaryl compound), carbonic acid derivatives, optionally chain terminators and optionally branching agents, wherein to produce the polyestercarbonates a portion of the carboxylic acid derivatives is replaced by aromatic dicarboxylic acids or derivatives of dicarboxylic acids, namely by aromatic dicarboxylic ester structural units depending on the carbonate structural units to be replaced in the aromatic polycarbonates.

Dihydroxyaryl compounds suitable both for production of polycarbonate compounds of the polycarbonate material and for production of polycarbonate by the process according to the invention are those of formula (1)

HO—Z—OH (1),

where
Z is an aromatic radical which has 6 to 30 carbon atoms and may contain one or more aromatic rings, may be substituted and may contain aliphatic or cycloaliphatic radicals/alkylaryls or heteroatoms as bridging members.
Z in formula (1) preferably represents a radical of formula (2)

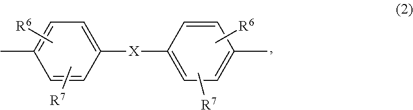

where
R⁶ and R⁷ independently of one another represent H, C₁ to C₁₈ alkyl, C₁ to C₁₈ alkoxy, halogen such as Cl or Br or respectively optionally substituted aryl or aralkyl, preferably H or C₁ to C₁₂ alkyl, particularly preferably H or C₁ to C₈ alkyl and very particularly preferably H or methyl, and
X represents a single bond, —SO₂—, —CO—, —O—, —S—, C₁ to C₆ alkylene, C₂ to C₈ alkylidene or C₅ to C₆ cycloalkylidene, which may be substituted with C₁ to C₆ alkyl, preferably methyl or ethyl, or else represents C₆ to C₁₂ arylene which may optionally be fused to further heteroatom-containing aromatic rings.
X preferably represents a single bond, C₁ to C₅ alkylene, C₂ to C₅ alkylidene, C₅ to C₆ cycloalkylidene, —O—, —SO—, —CO—, —S—, —SO₂—
or a radical of formula (2a)

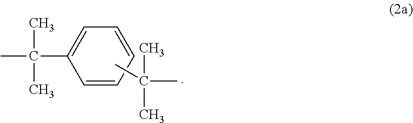

Examples of diphenols (i.e. dihydroxyaryl compounds) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl) diisopropylbenzenes and the ring-alkylated and ring-halogenated compounds thereof.

Diphenols suitable for the production according to the invention of the polycarbonate and for the production of the polycarbonate compound for the preferably recovered polycarbonate material include for example hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl) diisopropylbenzenes and the alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane (bisphenol A (BPA)), 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene, 1,1-bis(4-hydroxyphenyl)cyclohexane, and 1,1-bis(4-hydroxyphenyl)-3,3,5-trimethylcyclohexane (bisphenol TMC (BPTMC)), and also the diphenols of formulas (IV) to (VI)

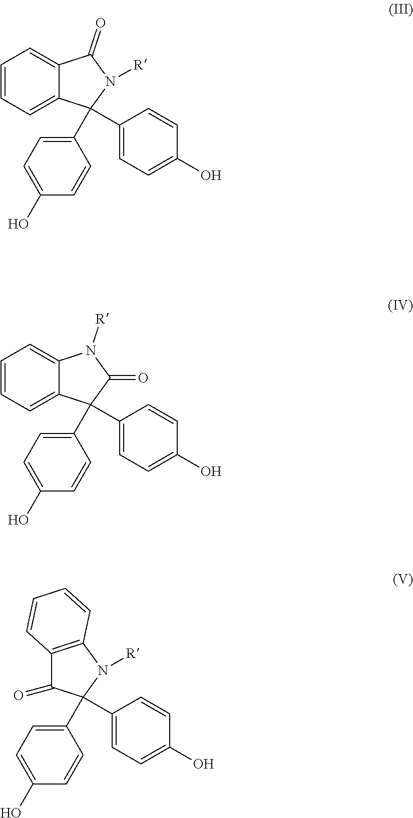

where R′ in each case represents C₁-C₄-alkyl, aralkyl or aryl, preferably methyl or phenyl.

Particularly preferred diphenols are 4,4′-dihydroxydiphenyl, 1,1-bis(4-hydroxyphenyl)phenylethane, 2,2-bis(4-hydroxyphenyl)propane (bisphenol A (BPA)), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC (BPTMC)), and the dihydroxy compounds of formulas (III), (IV) und (V), where R′ in each case represents C₁-C₄-alkyl, aralkyl or aryl, preferably methyl or phenyl.

These and further suitable diphenols are described, for example, in U.S. Pat. Nos. 2,999,835 A, 3,148,172 A, 2,991,273 A, 3,271,367 A, 4,982,014 A and 2,999,846 A, in German laid-open specifications DE 1 570 703 A1, DE 2 063 050 A1, DE 2 036 052 A1, DE 2 211 956 A1 and DE 3 832 396 A1, in French patent specification FR 1 561 518 A1, in the monograph “H. Schnell, Chemistry and Physics of Polycarbonates, Interscience Publishers, New York 1964, p. 28 ff.: p. 102 ff.”, and in “D. G. Legrand, J. T. Bendler, Handbook of Polycarbonate Science and Technology, Marcel Dekker New York 2000, p. 72 ff.”.

In the case of the homopolycarbonates only one diphenol is employed, while in the case of copolycarbonates two or more different diphenols are employed. The employed diphenol or the employed two or more different diphenols, similarly to all the other chemicals and auxiliaries added to the synthesis, may be contaminated with the impurities that originate from their own synthesis, handling and storage. It is however desirable to work with the purest possible raw materials.

Any branching agents or branching agent mixtures to be used are added to the synthesis in the same manner. Compounds typically used are trisphenols, quaterphenols or acyl chlorides of tri- or tetracarboxylic acids, or else mixtures of the polyphenols or of the acyl chlorides.

Some of the compounds having three or more than three phenolic hydroxyl groups that are usable as branching agents are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of the optionally employable branching agents is 0.05 mol % to 2 mol %, in turn based on moles of diphenols employed in each case, wherein the branching agents are initially charged with the diphenols.

All of these measures for producing a polycarbonate/a polycarbonate compound are familiar to those skilled in the art.

Examples of aromatic dicarboxylic acids that are suitable for the preparation of the polyestercarbonates include orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids include the dicarbonyl dihalides and the dialkyl dicarboxylates, especially the dicarbonyl dichlorides and the dimethyl dicarboxylates.

Replacement of the carbonate groups by the aromatic dicarboxylic ester groups is substantially stoichiometric, and also quantitative, and the molar ratio of the reactants is therefore also maintained in the final polyestercarbonate. The aromatic dicarboxylic ester groups may be incorporated either randomly or in blocks.

In a continuous interfacial process for producing polycarbonates known from EP 0 304 691 A2 an aqueous phase of diphenols and the particular amount of alkali metal hydroxide necessary is combined with a phosgene-containing organic phase in a tube using a static mixer. The phosgene excess of 20 to 100 mol % is very high and the residence time in the reaction tube for the first reaction step is 10 to 75 s. This process can be used for producing only prepolymers having a molecular weight of 4000 to 12 000 g/mol. This must be followed by a further condensation using at least one catalyst in order to arrive at the desired molecular weight. Suitable catalysts are tertiary amines and onium salts. It is preferable to employ tributylamine, triethylamine and N-ethylpiperidine.

The employed amine catalyst may be open-chain or cyclic, particular preference being given to triethylamine and N-ethylpiperidine. The catalyst is preferably used as a 1% to 55% by weight solution.

Onium salts are to be understood here as meaning compounds such as NR₄X, wherein R may be an alkyl and/or aryl radical and/or H and X is an anion, for example a chloride ion, a hydroxide ion or a phenoxide ion.

The fully reacted at least biphasic reaction mixture containing at most only traces (<2 ppm) of aryl chlorocarbonates is allowed to settle out for the phase separation. The aqueous alkaline phase (reaction wastewater) is removed and the organic phase is extracted with dilute hydrochloric acid and water. The combined water phases are sent to the wastewater workup where solvent and catalyst proportions are removed by stripping or extraction and recycled. Subsequently, after adjusting to a certain pH of for example 6 to 8, for example by addition of hydrochloric acid, any remaining organic impurities, for example monophenol and/or unconverted diphenol/unconverted diphenols, are removed by treatment with activated carbon and the water phase is sent to chloralkali electrolysis.

In another variant of the workup the reaction wastewater is not combined with the washing phases but after stripping or extraction to remove solvents and catalyst residues is adjusted to a certain pH of for example 6 to 8, for example by addition of hydrochloric acid, and after removal of the remaining organic impurities, for example monophenol and/or unconverted diphenol or unconverted diphenols, by treatment with activated carbon is sent to chloralkali electrolysis.

After removal of the solvent and catalyst proportions by stripping or extraction the washing phases may optionally be returned to the synthesis.

The carbonyl halide, in particular phosgene, may be used in liquid or gaseous form or dissolved in an organic solvent.

The production of phosgene from carbon monoxide and chlorine is known, for example from EP 0 881 986 A1, EP 1 640 341 A2, DE 332 72 74 A1, GB 583 477 A, WO 97/30932 A1, WO 96/16898 A1, or U.S. Pat. No. 6,713,035 B1.

After introduction of the phosgene it may be advantageous to subject the organic phase and the aqueous phase to stirring for a certain amount of time before optionally branching agents, if not added with the bisphenolate, chain terminators and catalyst are added. Such a postreaction time may be advantageous after any addition. These further stirring times are, insofar as they are introduced, between 10 seconds and 60 minutes, preferably between 30 seconds and 40 minutes, particularly preferably between 1 and 15 min.

The organic phase containing the polycarbonate must now be purified of all contamination of alkaline, ionic or catalytic type.

Even after one or more settling processes, optionally assisted by passage through settling tanks, stirred tanks, coalescers or separators and/or combinations of these measures—wherein water may optionally be added to each or some separation steps in some cases using active or passive mixing apparatuses—the organic phase still contains proportions of the aqueous alkaline phase in fine droplets as well as the catalyst, generally a tertiary amine.

After this coarse separation of the alkaline aqueous phase the organic phase is washed one or more times with dilute acids, mineral acids, carboxylic acids, hydroxycarboxylic acids and/or sulfonic acids. Aqueous mineral acids, in particular hydrochloric acid, phosphorous acid and phosphoric acid or mixtures of these acids, are preferred. The concentration of these acids should be in the range 0.001% to 50% by weight, preferably 0.01% to 5% by weight.

The organic phase is moreover subjected to repeated washing with demineralized or distilled water. The separation of the organic phase optionally dispersed with portions of the aqueous phase after the individual washing steps is carried out using settling tanks, stirred tanks, coalescers or separators and/or combinations of these measures, wherein the washing water may be added between the washing steps optionally using active or passive mixing apparatuses.

Between these washing steps or else after washing, there may be an optional addition of acids, preferably dissolved in the solvent used in the polycarbonate solution. Preference is given here to using hydrogen chloride gas and phosphoric or phosphorous acid which may optionally also be employed as mixtures.

After the last separating operation the thus-obtained purified polycarbonate solution should contain not more than 5% by weight, preferably less than 1% by weight, very particularly preferably less than 0.5% by weight, of water.

To isolate the polycarbonate the low-boiling solvent, for example methylene chloride, is exchanged for a high-boiling solvent, for example chlorobenzene, in a first step. This is accomplished using an exchange column.

Isolation of the polycarbonate from the solution with the high-boiling solvent, for example chlorobenzene, may be effected by evaporation of the solvent by means of temperature, vacuum or a heated entraining gas.

If the concentration of the polycarbonate solution and optionally also the isolation of the polycarbonate is accomplished by distillative removal of the solvent, optionally by superheating and decompression, this is referred to as a ‘flash process’, see also “Thermische Trennverfahren”, VCH Verlagsanstalt 1988, page 114: if by contrast a heated carrier gas is sprayed together with the solution to be concentrated this is referred to as ‘spray evaporation/spray drying’ as described for example in Vauck, “Grundoperationen chemischer Verfahrenstechnik”, Deutscher Verlag für Grundstoffindustrie 2000, 11th edition, page 690. All of these processes are described in the patent literature and in textbooks and are familiar to those skilled in the art.

Removal of the solvent through temperature (distillative removal) or the technically more effective flash process affords highly concentrated polycarbonate melts. In the known flash process a polycarbonate solution is repeatedly heated under a slight positive pressure to temperatures above its boiling point under atmospheric pressure and these solutions which are superheated in respect of atmospheric pressure are then decompressed into a vessel at lower pressure, for example atmospheric pressure. It may be advantageous not to allow the concentration stages, or in other words the temperature stages of the superheating, to become too substantial, but rather to opt for a two- to four-stage process.

The residues of the solvent can be removed from the thus-obtained highly concentrated polycarbonate melt either directly from the melt by means of vented extruders (BE-A 866 991, EP-A 0 411 510, US-A 4 980 105, DE-A 33 32 065), thin-film evaporators (EP-A-0 267 025), falling-film evaporators, strand evaporators or by friction compaction (EP-A-0 460 450), optionally also with addition of an entraining agent, such as nitrogen or carbon dioxide, or using vacuum (EP-A 0 039 96, EP-A 0 256 003, U.S. Pat. No. 4,423,207), alternatively also by subsequent crystallization (DE-A 34 29 960) and baking out the residues of the solvent in the solid phase (U.S. Pat. No. 3,986,269, DE-A 20 53 876).

Granulates are obtainable—where possible—by direct spinning of the melt and subsequent granulation or else by using discharge extruders from which spinning is effected in air or under liquid, usually water. When extruders are used, the melt may be admixed with additives upstream of the extruder, optionally using static mixers or via side extruders in said extruder.

The addition of additives to polycarbonate/to the polycarbonate compounds aids extension of service life or color (stabilizers), simplification of processing (e.g. demolding agents, flow auxiliaries, antistats) or adaptation of the properties of the resulting polycarbonate material to particular stresses (impact modifiers, such as rubbers: flame retardants, colorants, glass fibers).

These additives may be added to the polycarbonate melt individually or in any desired mixtures or a plurality of different mixtures, directly on isolation of the polycarbonate or the polycarbonate compound or else after melting pellets in a so-called compounding step to obtain polycarbonate material. These additives or mixtures thereof may be added to the polycarbonate melt as solid, i.e. as a powder, or as a melt. Another mode of metered addition is the use of masterbatches or mixtures of masterbatches of the additives or additive mixtures.

Examples of suitable additives are described in “Additives for Plastics Handbook, John Murphy, Elsevier, Oxford 1999” and in “Plastics Additives Handbook, Hans Zweifel, Hanser, Munich 2001”.

Examples of suitable antioxidants/thermal stabilizers include:
alkylated monophenols,
alkylthiomethylphenols,
hydroquinones and alkylated hydroquinones,
tocopherols,
hydroxylated thiodiphenyl ethers,
alkylidene bisphenols,
O—, N— and S-benzyl compounds,
hydroxybenzylated malonates,
aromatic hydroxybenzyl compounds,
triazine compounds,
acylaminophenols,
esters of β-(3,5-di-tert-butyl-4-hydroxyphenyl)propionic acid
esters of β-(5-tert-butyl-4-hydroxy-3-methylphenyl)propionic acid,
esters of β-(3,5-dicyclohexyl-4-hydroxyphenyl)propionic acid,
esters of 3,5-di-tert-butyl-4-hydroxyphenylacetic acid,
amides of β-(3,5-di-tert-butyl-4-hydroxyphenyl)propionic acid,
suitable thiosynergists,
secondary antioxidants, phosphites and phosphonites,
benzofuranones and indolinones.

Preference is given to organic phosphites, phosphonates, and phosphanes, mostly those in which the organic radicals consist completely or partially of optionally substituted aromatic radicals.

Suitable complexing agents for heavy metals and for the neutralization of traces of alkalis are ortho- and metaphosphoric acids, fully or partly esterified phosphates or phosphites.

Suitable light absorbers (UV absorbers) include for example:
2-(2′-hydroxyphenyl)benzotriazoles,
2-hydroxybenzophenones,
esters of substituted and unsubstituted benzoic acids,
acrylates,
sterically hindered amines,
oxamides,
2-(2-hydroxyphenyl)-1,3,5-triazines,
substituted benzotriazoles being preferred.

Polypropylene glycols, alone or in combination with, for example, sulfones or sulfonamides as stabilizers, may be used to counteract damage by gamma rays.

These and other stabilizers may be used individually or in combinations and may be added to the polycarbonate in the recited forms.

It is also possible to add processing aids such as demolding agents, mostly derivatives of long-chain fatty acids. Preference is given for example to pentaerythritol tetrastearate and glycerol monostearate. They are used alone or in a mixture, preferably in an amount of from 0.02% to 1% by weight, based on the mass of the composition.

Suitable flame retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacrylate, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

It is further possible to add colorants, such as organic dyes or pigments or inorganic pigments, IR absorbers, individually, as mixtures or else in combination with stabilizers, glass fibers, (hollow) glass spheres, inorganic fillers.

The abovementioned polycarbonate/the abovementioned polycarbonate compounds make it possible through further addition of the above-described additives to provide polycarbonate material employable for the production of a wide variety of commercial products. At the end of the use phase of products containing polycarbonate material, they are usually disposed of, i.e. stored in landfills or incinerated in waste incineration plants. A materials recovery by milling and remelting is only performable in some cases, i.e. it has hitherto not always been possible to recover the employed polycarbonates from the polycarbonate materials in an economic purity.

For the RWGS synthesis it is necessary according to the present invention to provide a purified CO₂ gas stream, which is distinct from the carbon dioxide separated in the separation and not reacted in the RWGS reaction, and the process product of a method containing at least the steps of:
providing a CO₂ gas stream,
purifying the CO₂ gas stream of secondary components (in particular nitrogen oxides, sulfur compounds, phosphorus compounds, dust, water, oxygen and HCl) optionally by adsorption, gas scrubbing or catalytic treatment to obtain a gas stream of purified carbon dioxide.

When providing the purified CO₂ gas stream it is accordingly adequate when the purified CO₂ gas stream is a process product of the abovementioned method. This means that when performing the process according to the invention it is sufficient when performing the step of providing a purified CO₂ gas stream to withdraw said purified CO₂ gas stream as raw material from a storage container or from a feed conduit merely in the context of a delivery. In this case the polycarbonate producer as the performer of the process according to the invention does not itself perform the abovementioned method for producing said CO₂ but rather only ensures that the provided CO₂ has been produced by said method by the supplier.

It is likewise possible according to the invention when to provide the purified CO₂ gas stream the abovementioned steps of the production method of the purified CO₂ gas stream are performed as integral steps of a process according to the invention for producing polycarbonate by the polycarbonate producer and the resulting purified CO₂ gas stream is directly supplied to the RWGS reaction zone for reaction.

These possibilities for providing, i.e. delivery or own production by the polycarbonate producer, also apply to the following embodiments of providing the purified CO₂ gas stream.

A preferred embodiment of the process of the invention is characterized in that the RWGS synthesis employs carbon dioxide which has been provided as carbon dioxide from the recovery of polycarbonate material waste by incineration and/or by pyrolysis and has been purified in the purification. It is in turn preferable when the incineration utilizes oxygen gas obtained from the water electrolysis.

The polycarbonate material waste may have been formed by commercial use of polycarbonate material, wherein the polycarbonate material was produced using polycarbonate as the polycarbonate compound and was provided as polycarbonate as per the process according to the invention. When recovering such a polycarbonate material waste in the RWGS synthesis according to the invention, the process is referred to as a so-called “closed loop” process. However, it is naturally also possible for the RWGS synthesis of the present invention to recover CO₂ from the incineration of polycarbonate material waste containing polycarbonate compounds not produced as polycarbonates according to the process according to the invention.

Very particular preference is given to a process which employs for the RWGS synthesis carbon dioxide formed from the recovery of polycarbonate material waste by incineration in the presence of gas having an oxygen gas content (O₂) wherein said gas has an oxygen gas content (O₂) of at least 30% by volume, preferably of at least 50% by volume, particularly preferably of at least 95% by volume, very particularly preferably of at least 99% by volume, most preferably of at least 99.5% by volume.

The oxygen gas used for incineration may in turn preferably be obtained from a water electrolysis.

Recovery of the polycarbonate material waste is carried out in the context of the providing of the CO₂ gas stream for example by pyrolysis of said polycarbonate material waste at elevated temperature, optionally in the presence of catalyst, to obtain carbon dioxide, optionally carbon monoxide, optionally hydrogen, optionally a mixture of aliphatic and aromatic low molecular weight hydrocarbons and nitrogen-containing hydrocarbons and optionally a residue of higher molecular weight hydrocarbons having more than eight carbon atoms. The mixture obtained in the pyrolysis is then preferably supplied to a refining to obtain a gas mixture of carbon dioxide, carbon monoxide, hydrogen gas, and further low molecular weight hydrocarbon compounds that are gaseous under standard conditions.

The incineration of the residue obtained in the pyrolysis and optionally of further polycarbonate material waste may be carried out in particular with oxygen-containing gas, in particular with pure oxygen, to obtain carbon dioxide-containing gas.

In a preferred embodiment of the novel process the RWGS synthesis employs carbon dioxide formed from the incineration of polycarbonate material waste using oxygen obtained from a water electrolysis.

In a further preferred embodiment of the novel process a water electrolysis and/or the chloralkali electrolysis are performed using electricity generated from renewable energy, in particular from renewable energy in the form of wind power, solar power or hydro power.

In another preferred embodiment of the novel process a water electrolysis and/or the chloralkali electrolysis are performed using electricity from feedback energy obtained during the incineration of polycarbonate material waste and/or the performing of the RWGS reaction.

A further alternative embodiment of the novel process is characterized in that the RWGS reaction (6) is supplied with heat energy produced by means of electricity (28) generated from renewable energy, in particular electricity obtained through the use of wind power, solar power or hydro power as desired.

In a further alternative embodiment of the novel process the supplying of heat energy to the RWGS reaction is performed using feedback energy obtained from the incineration of polycarbonate material waste. The term “feedback energy” is understood by a person skilled in the art to mean energy, in particular heat energy that has been withdrawn from a process step of the process according to the invention (optionally converted into another energy form, for example electricity) and reintroduced in another process step of the process according to the invention.

In a preferred variant of the novel process, the RWGS reaction is heated by burning hydrocarbons from renewable hydrocarbon production, in particular by burning biomethane. Biomethane is here understood as meaning methane obtained from the biogas that is produced by the fermentation of biomass. A further particularly preferred variant of the novel process is characterized in that after its use the polycarbonate material is recycled as polycarbonate material waste and the polycarbonate material waste is incinerated to afford carbon dioxide and the carbon dioxide is employed as an input material in the purifying.

The oxygen for the incineration is preferably obtained from a water electrolysis.

By preferably using electricity from renewable energy (preferably from wind power, from hydro power or from solar power), CO₂ emissions in the overall process are further reduced.

In a particularly preferred embodiment of the process according to the invention the materials cycle is further closed in that in order to provide the CO₂ gas stream polycarbonate material after its use is recycled as polycarbonate material waste and the polycarbonate material waste is incinerated to afford carbon dioxide and the carbon dioxide is employed as input material in the purification.

In the abovementioned recycling of polycarbonate material at the end of its service life customary separation methods for separating composite materials in waste are employed. The polycarbonate material for instance undergoes an automated or manual coarse separation and is then mechanically comminuted and optionally separated further. The polycarbonate material obtained serves as feedstock polycarbonate material waste for incineration or pyrolysis.

In the case of incineration the polycarbonate material waste is reacted for example with pure oxygen O₂ which evolves at the anode as a product of the water electrolysis. The heat of reaction evolved during incineration can be used as feedback energy for the production of steam and/or electricity. In particular, the heat can be used to operate a pyrolysis and the electricity generated may be used in the electrolysis, in particular the chloralkali electrolysis or the water electrolysis. This further improves the overall efficiency of the novel process.

The heat obtained during incineration may also be used as feedback energy for heating the RWGS reaction, thus further improving the energy efficiency of the novel process as a whole relative to the prior art.

The CO₂ deriving from incineration or pyrolysis of the polycarbonate material waste is obtained in highly concentrated form and is supplied to a purification before further use, thus forming a purified CO₂ gas stream. This separates the byproducts of the incineration, for example sulfur compounds such as SO₂, nitrogen compounds such as NOx, and residual organics as well as dust and other compounds formed from the components present in the polycarbonate material.

The incineration of the polycarbonate material waste with pure oxygen may be carried out, for example, according to the process known as the oxyfuel process in an atmosphere of pure oxygen and CO₂ (recirculating flue gas). The resulting flue gas is not diluted with the nitrogen present in air and consists essentially of CO₂ and water vapor. The water vapor can be easily condensed, with the result that a highly concentrated CO₂ stream (concentration in the ideal case close to 100 percent) is formed. The CO₂ can then be purified and further processed, optionally also compressed and stored.

In addition, some of the energy obtained during the pyrolysis or during the incineration of the polycarbonate material may be converted into steam or electricity. As mentioned above, the electricity obtained can be used to operate the electrolysis or the heating of the RWGS, thus resulting in an even more efficient process with low consumption of electrical energy.

The purification of the CO₂ from combustion gases can be carried out using processes generally known from the prior art. This is described by way of example hereinbelow.

The first step here is, for example, purification of the combustion gases, the main component of which is CO₂. The setup for a combustion gas purification is subdivided into different stages. The particular task of purification is to provide CO₂ for the subsequent RWGS reaction that is free of interfering secondary constituents.

In the first stage, dust is removed from the combustion gas. This can be done with fabric filters or with an electrostatic filter. Any acidic gas present, such as hydrogen chloride formed from chlorine compounds present in the waste, can then be removed. This is done using, for example, offgas scrubbing towers. The combustion gas is thereby also cooled and freed from further dusts and any heavy metals present. In addition, sulfur dioxide gas that has formed is also removed in a scrubbing circuit and reacted for example with slaked lime to form calcium sulfate. The removal of nitrogen compounds from the combustion gases can be carried out for example on catalyst-containing zeolites or by adding urea or ammonia to convert the nitrogen oxides back to nitrogen and water. To prevent formation of ammonium salts, which would clog the catalyst pores the catalysts are usually operated at a temperature of above 320° C. The nitrogen compounds may also be removed by scrubbing with nitric acid or scrubbing with catalysts.

The drying and further purification of the CO₂ can be effected by known conventional methods. Drying for example by treatment with concentrated sulfuric acid.

In the final purification stage, activated carbon filters are used to remove any residual organics and last metal residues still present in the combustion gas by means of activated carbon. This can be done using, for example, activated carbon in dust form that is metered into the combustion gas stream or flue gas stream and then deposited again on the fabric filter together with the accumulated contaminants. The used carbon is discharged and sent for energetic recovery (described in principle in: https://www.ava-augsburg.de/umwelt/rauchgasreinigung/).

The purification processes performed on the combustion gases provide a CO₂ that can be used as a feedstock for the RWGS reaction.

In gas streams that have a lower concentration of CO₂, CO₂ can also optionally be separated by amine scrubbing.

In the case of the pyrolysis, supply of additional oxygen gas to the pyrolysis reaction space is not preferred. The pyrolysis of the used polycarbonate material waste may preferably be performed as follows:

The pyrolysis of the polycarbonate material is carried out at elevated temperature, optionally in the presence of a catalyst, to obtain possibly carbon dioxide, possibly carbon monoxide, possibly hydrogen, a mixture of aliphatic and aromatic low molecular weight hydrocarbons and nitrogen-containing hydrocarbons and a residue of higher molecular weight hydrocarbon compounds,
optionally refining the resulting mixture of low molecular weight hydrocarbons to obtain a mixture of gaseous and liquid hydrocarbons and a mixture of carbon dioxide and carbon monoxide, hydrogen and other gaseous hydrocarbon compounds, and separating the resulting mixtures in a gas separation,
incinerating the obtained residue and optionally further polycarbonate material waste with oxygen-containing gas, in particular with pure oxygen, to obtain carbon dioxide-containing gas.

The polycarbonate material waste recycled and comminuted as described above may be supplied to the pyrolysis, wherein the pyrolysis may be performed with or without catalyst as desired.

The fractions formed during the pyrolysis are gaseous, liquid and solid, with the solid phase usually consisting predominantly of pyrolytic carbon. The liquid long-chain carbon compounds containing aromatics such as toluene, benzene, and xylene are preferably supplied to a refining process.

In addition, the pyrolysis can optionally be operated in particular in such a way that larger amounts of carbon monoxide and possibly hydrogen are generated. These gases can be separated off together with the short-chain hydrocarbon compounds, for example in the refining step, or they can also be separated off separately and then supplied to a carbon monoxide-hydrogen separation and be used.

The solid substances obtained during the pyrolysis consist mostly of carbon. This solid phase can be reacted with pure oxygen from the water electrolysis. This also gives rise to a highly concentrated stream of CO₂, which is supplied to a purification step.

Another option for producing high-purity CO₂ is to absorb the CO₂ in an alkali solution, for example aqueous potassium hydroxide solution. This results in the formation of potassium hydrogen carbonate, which can then be thermally decomposed back to CO₂ and potassium hydroxide. Heat generated from pyrolysis or incineration can be used here.

The purified CO₂ is provided as purified CO₂ gas stream and supplied to the RWGS reaction.

The product gas mixture of the RWGS reaction is subjected to a separation of gaseous water present in the product gas mixture. The product gas mixture withdrawn from the RWGS reaction is preferably cooled for this purpose. This separates the reaction water. The separated water may be recycled to a water electrolysis or the chloralkali electrolysis as raw material. After the water separation, the gas is supplied to the CO₂ separation.

The CO₂ separation is carried out for example by means of an amine scrubbing step in which the CO₂ is removed and the residual gas of CO and H₂ is supplied to a H₂—CO gas separation unit. The CO obtained is then supplied to the phosgene synthesis and reacted here with Cl₂ to form phosgene. The phosgene produced is sent to the polycarbonate production. In the polycarbonate production the phosgene is reacted with at least one diol to afford a polycarbonate compound and optionally sodium chloride.

Preference is therefore given to an embodiment of the novel process in which at least substreams of the carbon monoxide and/or of the hydrogen from the H₂—CO separation are supplied to an RWGS reaction.

The novel process may also preferably be operated in such a way that a portion of the polycarbonate material waste is supplied directly to the incineration instead of the pyrolysis.

If alkali metal chloride, in particular sodium chloride, is generated during the polycarbonate production this may be sent to a chloralkali electrolysis. In a preferred embodiment the process according to the invention to this end contains the separation and purification of the sodium chloride solution formed in the polycarbonate production and subsequent supply of said sodium chloride to an electrochemical reaction of the sodium chloride present in aqueous solution to afford chlorine and optionally sodium hydroxide solution. The sodium chloride obtained after separation and purifying of the sodium chloride solution formed in the polycarbonate production is also referred to as processed sodium chloride. The chlorine formed in this preferred step is in turn preferably supplied to the phosgene synthesis. The sodium hydroxide solution formed may for example be sent to the step of reacting at least phosgene with at least one diol to afford at least one polycarbonate. A suitable example of said electrochemical reaction is inter alia especially the chloralkali electrolysis already performed in the context of the process according to the invention.

In the context of a particularly preferred embodiment said electrochemical reaction is performed using electricity generated from renewable energy, in particular using electricity obtained as desired through the use of wind power, solar power or hydro power.

In the context of the process according to the invention a chloralkali electrolysis is performed for providing chlorine and hydrogen.

The process of chloralkali electrolysis is more particularly described below. The description which follows is to be considered as exemplary in respect of the electrolysis of sodium chloride since in the process as described above for example any alkali metal chloride may in principle be employed (in particular LiCl, NaCl, KCl) but the use of sodium chloride/sodium hydroxide solution in the preceding steps is the preferred embodiment of the process.

It is customary to employ membrane electrolysis processes for electrolysis of sodium chloride-containing solutions for example. This employs for example an electrolysis cell divided into two, which comprises at least an anode space comprising an anode and a cathode space comprising a cathode. Anode and cathode spaces are separated by an ion exchanger membrane. A sodium chloride-containing solution having a sodium chloride concentration of typically more than 300 g/l is introduced into the anode space. At the anode the chloride ion is oxidized to chlorine which is discharged from the cell with the depleted sodium chloride-containing solution (about 200 g/l). The sodium ions migrate through the ion exchanger membrane into the cathode space under the influence of the electric field. During this migration each mole of sodium entrains between 3.5 and 4.5 mol of water depending on the membrane. This has the result that the anolyte is depleted in water. In contrast to the anolyte, water is consumed on the cathode side through electrolysis of water to afford hydroxide ions and hydrogen. The water that passes into the catholyte with the sodium ions is sufficient to keep the sodium hydroxide solution concentration in the outflow at 31-32% by weight at an inflow concentration of 30% and a current density of 4 kA/m2. In the cathode space water is electrochemically reduced to form hydroxide ions and hydrogen.

In the sodium chloride electrolysis additional water is introduced into the anolyte via the sodium chloride-containing solution but water is only discharged into the catholyte via the membrane. If more water is introduced via the sodium chloride-containing solution than can be transported to the catholyte, the anolyte is depleted in sodium chloride and the electrolysis cannot be operated continuously. At very low sodium chloride concentrations the side reaction of oxygen formation would occur.

To economically supply the maximum amounts of sodium chloride-containing solutions to the sodium chloride electrolysis it may be advantageous for the water transport via the membrane to be increased. This may be done by selection of suitable membranes as described in U.S. Pat. No. 4,025,405. The effect of elevated water transport is that the otherwise usual water addition to maintain the aqueous hydroxide concentration may be dispensed with.

In U.S. Pat. No. 3,773,634 the electrolysis can be operated at high water transport through the membrane when an aqueous hydroxide concentration of 31% to 43% by weight and a sodium chloride concentration of 120 to 250 g/l is employed.

A further option of using more than one sodium chloride-containing solution from polycarbonate production is that of concentrating this solution, for example by membrane processes such as reverse osmotic distillation or by thermal concentration. If the evaporation is performed to beyond the saturation limit the entire sodium chloride may be recycled, thus closing the value cycle.

Reference is made expressly and in full to the content of the abovementioned documents cited in connection with the production of chlorine gas.

In the context of a particularly preferred embodiment the chloralkali electrolysis is performed using electricity generated from renewable energy, in particular using electricity obtained as desired through the use of wind power, solar power or hydro power.

The polycarbonates are used in various commercial applications. At the end of their useful life, the materials are supplied to a recycling unit and the PC-containing materials separated here. The separated material is then resupplied, as polycarbonate material waste, for recovery in the form of pyrolysis and/or incineration.

This eliminates the need for further fossil feedstocks for polycarbonate production, allowing polycarbonate material to be produced in a more sustainable manner.

The process according to the invention may preferably be executed with an apparatus according to the invention as a further subject of the invention, wherein this apparatus is adapted for performing the process according to the invention.

A preferred embodiment for a correspondingly suitable apparatus system for producing polycarbonate comprises at least the following apparatus parts in the following configuration
at least one electrolyzer for chloralkali electrolysis containing at least one inlet for an aqueous solution of alkali metal chloride, in particular of sodium chloride, at least one outlet for chlorine and at least one outlet for hydrogen;
at least one RWGS reactor containing at least one RWGS reaction zone, at least one heating element as an apparatus for supplying heat energy to the RWGS reaction zone and at least one inlet for introducing CO₂ and hydrogen into the RWGS reaction zone and at least one outlet for the carbon monoxide-containing product gas from the RWGS reactor, with the proviso that
   (i) at least one inlet for introducing hydrogen into the RWGS reaction zone is in fluid connection with at least one outlet for hydrogen of the at least one electrolyzer for the chloralkali electrolysis and
   (ii) at least one inlet for introducing CO₂ into the RWGS reaction zone is in fluid connection with at least one supplying source of a purified CO₂ gas stream which has been produced by at least the steps of:
      a) providing a CO₂ gas stream,
      b) purifying the CO₂ gas stream of secondary components (in particular nitrogen oxides, sulfur compounds, phosphorus compounds, dust, water, oxygen and HCl) optionally by adsorption, gas scrubbing or catalytic treatment and
   (iii) at least one outlet for the carbon monoxide-containing product gas from the RWGS reactor is in fluid connection with the water separation;
at least one apparatus for separating water which comprises at least one inlet which is in fluid connection with the outlet for the carbon monoxide-containing product gas from the reformer and at least one outlet for the separated water and at least one outlet for the dried carbon monoxide-containing product gas;
at least one apparatus for separating CO₂ which comprises at least one inlet which is in fluid connection with the outlet for the dried carbon monoxide-containing product gas from the apparatus for separating water and at least one outlet for the separated CO₂ which is in fluid connection with an inlet for CO₂ of the RWGS reactor and at least one outlet for the prepurified, carbon monoxide-containing product gas;
at least one apparatus for separating H₂—CO containing at least one inlet which is in fluid connection with the outlet for the prepurified, carbon monoxide-containing product gas from the apparatus for separating CO₂, at least one outlet for the carbon monoxide and at least one outlet for the residual gas from the H₂—CO separation;
at least one apparatus for producing phosgene which comprises at least one inlet for carbon monoxide which is in fluid connection with the outlet of the apparatus for separating H₂—CO provided for the carbon monoxide and contains at least one outlet for phosgene and at least one inlet for chlorine, wherein at least one inlet for chlorine is in fluid connection with at least one outlet for chlorine of said electrolyzer;
at least one apparatus for producing polycarbonate containing at least one inlet for diol, at least one outlet for polycarbonate and at least one inlet for phosgene which is in fluid connection with at least one outlet for phosgene of the apparatus for producing phosgene.

According to the invention a “fluid connection” is to be understood as meaning an apparatus part which connects apparatuses of the apparatus system with one another and by means of which a substance which may be in any physical state of matter may be transported from one apparatus to another apparatus of the apparatus system by a material stream, for example a feed conduit in the form of a pipe, which may be interrupted by further apparatuses.

Analogously to the above-described process it is likewise preferable in the context of a preferred embodiment of the apparatus system when the outlet for the residual gas of the apparatus for H₂—CO separation is in fluid connection with at least one inlet for hydrogen of the RWGS reactor. For utilization of the hydrogen gas from the residual gas of the apparatus for H₂—CO separation for synthesis purposes it is preferable when the outlet for the residual gas of the apparatus for H₂—CO separation is in fluid connection with the inlet of an apparatus for residual gas treatment, wherein said apparatus for residual gas treatment has at least one outlet for hydrogen gas and at least one outlet for residual gas of the residual gas treatment. In this case it is preferable when the outlet for the residual gas of the apparatus for the residual gas treatment is in fluid connection with the heating element of the RWGS reactor, in particular with the combustion chamber of the heating element.

For the synthesis of polycarbonate it is advantageous in the context of a preferred embodiment of the apparatus system when at least one outlet for polycarbonate of the apparatus for producing polycarbonate is in fluid connection with at least one inlet of an apparatus for compounding. It is particularly preferable when the apparatus for compounding contains not only the at least one inlet for polycarbonate but also at least one inlet for dyes, at least one inlet for a polymer as a blend partner and at least one outlet for polycarbonate material. Suitable polymers (blend partners) according to the invention preferably include at least one of the abovementioned impact modifiers.

The supply source of a purified CO₂ gas stream is in the context of a preferred embodiment of the RWGS reactor a CO₂ supply apparatus containing
at least one reactor for production of CO₂ which comprises at least one outlet for carbon dioxide-containing product gas and
at least one purifying apparatus containing (i) at least one inlet for carbon dioxide-containing product gas which is in fluid connection with at least one outlet for carbon dioxide-containing product gas of the reactor for production of CO₂ and (ii) at least one outlet for a purified CO₂ gas stream which is in fluid connection with at least one inlet for purified CO₂ gas stream of the RWGS reactor.

In a more preferred embodiment the reactor for production of CO₂ has at least one inlet for introduction of polycarbonate material waste and at least one inlet for introduction of oxygen-containing gas. It is in turn preferable when the apparatus system additionally comprises at least one electrolyzer for water electrolysis whose outlet of oxygen gas is in fluid connection with at least one inlet for introduction of oxygen-containing gas of the reactor for production of CO₂.

The invention further provides for the use of provided carbon monoxide obtained by a process containing the steps of
providing a purified CO₂ gas stream produced by a method containing at least the steps of:
   providing a CO₂ gas stream,
   purifying the CO₂ gas stream of secondary components (in particular of nitrogen oxides, sulfur compounds, dust, water, oxygen and HCl) optionally by adsorption, gas scrubbing or catalytic treatment to obtain a gas stream of purified carbon dioxide,
introducing hydrogen together with the purified CO₂ gas stream into an RWGS reaction zone and reaction of the reactants according to the principle of RWGS to afford a product gas mixture containing not only unconverted reactant but also steam, CO and optionally byproducts, in particular lower hydrocarbons, especially preferably methane,
separating the water of the steam from the product gas mixture,
separating unreacted carbon dioxide from the gas mixture of the RWGS reaction obtained from the separation, in particular by means of amine scrubbing, and recycling the unreacted carbon dioxide to the RWGS reaction,
separating the hydrogen unconverted in the RWGS reaction from the gas mixture of carbon monoxide and hydrogen obtained after the separation, in particular using a coldbox, and recycling the separated hydrogen into the RWGS reaction,
   to produce polycarbonate by at least the steps of
producing at least chlorine and hydrogen by chloralkali electrolysis of alkali metal chloride, preferably sodium chloride, in aqueous solution,
introducing the provided carbon monoxide into a phosgene synthesis,
supplying the previously formed chlorine into the phosgene synthesis,
synthesizing phosgene from carbon monoxide and chlorine,
reacting at least phosgene with at least one diol to afford at least one polycarbonate.

The preferred embodiments described previously for the process subject matter of the invention likewise apply mutatis mutandis for this use subject matter of the invention and the features contained therein.

The invention is more particularly elucidated by way of example below with reference to the figures.

In the figures:

FIG. 1 shows a schematic overview of the overall process comprising the RWGS reaction, chlorine production, PC production, use, and recovery of the polycarbonate material waste therefrom to afford CO₂ for the RWGS reaction

FIG. 1 shows a process for producing polycarbonate comprising at least the steps of
producing at least chlorine 22 and hydrogen 29b by chloralkali electrolysis 14 of alkali metal chloride, preferably sodium chloride, in aqueous solution,
providing a purified CO₂ gas stream 33 produced by a method containing at least the steps of:
   providing a CO₂ gas stream 31
   purifying 4 the CO₂ gas stream 31 of secondary components (in particular of nitrogen oxides, sulfur compounds, dust, water, oxygen and HCl) optionally by adsorption, gas scrubbing or catalytic treatment to obtain a gas stream of purified carbon dioxide 33,
introducing hydrogen 29a together with the purified CO₂ gas stream 33 into an RWGS reaction zone and reaction 6 of the reactants according to the principle of RWGS to afford a product gas mixture 39 containing not only unconverted reactant but also steam 26b, CO 21 and optionally byproducts 32, in particular lower hydrocarbons, especially preferably methane,
separating 7 the water of the steam 26b from the product gas mixture 39,
separating 8 unconverted carbon dioxide 31b from the gas mixture 39a of the RWGS reaction 6 obtained from the separation 7, in particular by amine scrubbing, and recycling the unconverted carbon dioxide 31b into the RWGS reaction 6,
separating 9 the hydrogen unconverted in the RWGS reaction 6 from the gas mixture 39b of carbon monoxide and hydrogen obtained after the separation 8, in particular using a coldbox, and recycling the separated hydrogen 29c into the RWGS reaction 6,
introducing the remaining carbon monoxide 21 from the separation 9 into the phosgene synthesis 1,
supplying the previously formed chlorine 22 into the phosgene synthesis 1,
synthesizing 1 phosgene 20 from carbon monoxide 21 and chlorine 22,
reacting 2 at least phosgene 20 with at least one diol 23 to afford at least one polycarbonate 24.

It is preferable when according to FIG. 1 the RWGS synthesis 6 employs purified carbon dioxide 33 which is provided from the recovery 10 of polycarbonate material waste 38 by incineration 10b and/or by pyrolysis 10a as carbon dioxide 31a and is purified in the purification 4.

It is in turn preferable when according to the process of FIG. 1 as recovery 10 an incineration 10b using gas having an oxygen gas content (O₂) of at least 30% by volume can be performed, in particular using oxygen gas 27a which is obtained from a water electrolysis 5. In a preferred embodiment the water electrolysis 5 is performed using electricity 28a generated from renewable energy, in particular from renewable energy in the form of wind power, solar power or hydro power. Heat energy 19 for energy and steam production 13 may be diverted from the recovery 10 and the RWGS reaction 6, wherein the water electrolysis 5 may additionally be operated with electricity 15 generated in the energy production 13.

According to FIG. 1 the RWGS reaction 6 is supplied with heat energy which is either produced by means of electricity 28 generated from renewable energy, in particular electricity obtained using wind power, solar power or hydro power as desired. The heating of the RWGS reaction 6 is further effected by burning of hydrocarbons from renewable sources, in particular by burning of biomethane.

According to the process illustrated in FIG. 1 preferred provision of the CO₂ gas stream 31 preferably comprises employing polycarbonate material 37 after use 80 thereof to obtain end-of-life products containing polycarbonate material 37 and subsequently recycling the polycarbonate material waste 38 obtained from the recycling 90 of the end-of-life products and incinerating said material to afford carbon dioxide 31c, wherein the carbon dioxide 31c is sent for purification 4 as input material 31 (closed-loop recycling). It is likewise possible according to FIG. 10 to also employ for recovery 10 polycarbonate material waste 38 deriving from polycarbonate material 37 not produced by the process according to the invention.

Furthermore, it is preferable when in the process depicted in FIG. 1, in the reaction 2 of at least phosgene 20 with at least one diol 23, not only at least one polycarbonate but also alkali metal chloride in solution 25 is formed and this solution is subjected to a separation and purification 11, wherein said separated and purified alkali metal chloride 25a present in aqueous solution is supplied to the chloralkali electrolysis 14.

In the process of FIG. 1 the chloralkali electrolysis 14 is preferably performed using electricity 28a generated from renewable energy, in particular electricity 28a obtained through the use of wind power, solar power or hydro power as desired.

FIG. 1 additionally shows an embodiment of the process in which the reaction 2 of at least phosgene 20 with at least one diol 23 to afford at least one polycarbonate 24 is additionally supplied with alkali metal hydroxide solution 30 obtained from the chloralkali electrolysis 14.

According to the process of FIG. 1 the polycarbonate 24 obtained from the reaction 2 may be converted into polycarbonate material 37 preferably in the compounding 3 by addition of colorants or further additives 35a and at least one further polymer as a blend partner 35b (for example polystyrene copolymer).

In FIG. 1, the following reference numerals are defined on the right-hand side as follows:
1 Phosgene synthesis
2 Polycarbonate production
3 Compounding to produce polycarbonate material 37
4 CO₂ gas purification
5 Water electrolysis
6 RWGS reaction (reverse water gas shift reaction)
7 Water separation
8 CO₂ separation
9 H₂—CO separation
10 Recovery of polycarbonate material waste 38 by pyrolysis (10a) and/or incineration (10b)
10a Pyrolysis
10b Incineration
11 Workup of NaCl from wastewater 25
13 Energy and steam generation
14 Chloralkali electrolysis to produce Cl₂ and H₂ and preferably alkali metal hydroxide solution
15 Electricity from energy/steam (13)
19 Heat
Phosgene from phosgene synthesis 1
21 Separated carbon monoxide from the H₂—CO separation 9
22 Chlorine gas
23 Diol (for example bisphenol A)
24 Polycarbonate
25 Alkali metal chloride-containing wastewater, in particular NaCl-containing wastewater
25a Worked-up alkali metal chloride-containing wastewater, in particular worked-up sodium chloride-containing wastewater
26 Water
26a Separated water from product gas mixture 39 of the RWGS reaction
27 Oxygen from water electrolysis
27a Oxygen from water electrolysis for other uses
28 Bio-natural gas and/or renewable energy only for heating
28a Electricity from renewable energy
29 Hydrogen from water electrolysis
29a Hydrogen for the RWGS reaction
29b Hydrogen from the chloralkali electrolysis 14
29c Separated hydrogen from the H₂—CO separation
30 Aqueous solution of alkali metal hydroxide, preferably sodium hydroxide
31 CO₂ for supplying to CO₂ gas purification 4
31a CO₂ from renewable source
31b Unconverted CO₂ from CO₂ separation
31c CO₂ from 10
32 Separated byproducts from the RWGS reaction
33 Purified CO₂
35a Colorant or other additives
35b Polymer as a blend partner (for example polystyrene copolymer)
37 Polycarbonate material
38 Polycarbonate material-containing waste (polycarbonate material waste) for 10
39 Product gas mixture from the RWGS reaction consisting of carbon monoxide, water, CO₂, hydrogen and byproducts
39a 39 with reduced water content
39b 39a with decreased content of CO₂
80 Commercial use of 37
90 Polycarbonate-based materials—end-of-life recycling

Arrows in the figure symbolize the flow of substances, energy or heat between process steps/through a fluid connection provided for this purpose between apparatus parts in which the corresponding process steps are performed. Dashed lines in the figures denote parts of preferred embodiments of individual above-described features of the process. A filled circle represents a node of a material flow.

FIG. 2 shows a schematic overview of the process described in example 1 comprising the RWGS reaction, a chloralkali electrolysis including PC production, use of the polycarbonate material and recovery of the polycarbonate material waste therefrom to afford CO₂ for the RWGS reaction.

The assignment of the reference numbers used in FIG. 2 is as defined for FIG. 1.

### Example 1

Inventive Production of Low-Emission Polycarbonate, CO Production Using RWGS, Heating Thereof being Effected with Bio-Natural Gas, NaCl Recycling and Use in Chloralkali Electrolysis

17.84 t/h of CO₂ and 0.81 t/h of H₂ are introduced into an RWGS reaction space (6) operated at a temperature of 802° C. The obtained product gas mixture (39) consisting of CO, H₂O, unconverted CO₂ and also unconverted H₂ and byproducts, mainly small amounts of methane, is withdrawn from the RWGS reaction and sent to a water separation (7) in which 7.29 t/h of water (26b) are separated. This water (26b) may be at least partially returned to the chloralkali electrolysis. A total of 0.81 t/h of hydrogen (29b) are removed from the chloralkali electrolysis (14). The remaining gas mixture (39a) from the H₂O separation (7) is sent to a CO₂ separation (8). The CO₂ separation is effected by amine scrubbing, wherein the separated CO₂ (31b) is recycled to the RWGS reaction. The energy for CO₂ separation from the CO₂-amine complex formed is obtained from the water separation (7) in which the RWGS reaction gases (39) are cooled. The gas freed of CO₂ (39b) is sent to the H₂—CO separation (9). For the H₂—CO separation, a so-called coldbox is employed, in which the H₂—CO gas mixture is cooled and hydrogen and CO are separated. The separated hydrogen (29c) is returned to the RWGS reaction (6). 11.35 t/h of CO are supplied from the H₂—CO separation (9) to a phosgene synthesis (1). The CO reacted with 28.8 t/h of chlorine taken from a Cl₂ production by chloralkali electrolysis (14). 40.15 t/h of phosgene are withdrawn from the phosgene synthesis (1) and in a polycarbonate production as a solution in chlorinated solvent (for example 435 t/h of a 1:1 mixture of methylene chloride and chlorobenzene) (2) reacted with 540 t/h of 15% by weight bisphenol A solution (81 t/h of BPA corresponding to 354.8 kmol) in alkaline water (comprising 2.13 mol of NaOH per mole of bisphenol A corresponding to 755.7 kmol of NaOH=30.2 t/h of NaOH and 64.17 t of H₂O as 32% by weight sodium hydroxide solution)) as diol (23) to afford 92.72 t/h of polycarbonate (24) using at least one chain terminator (for example 2.3 t/h of tert-butylphenol). 29 t/h of further 22% by weight NaOH solution (6.38 t/h of NaOH and 17.84 t/h of H₂O as 32% sodium hydroxide solution) and at least one catalyst (for example 0.45 t/h of N-ethylpiperidine). 32.45 t/h of NaOH with 68.95 t/h of water are obtained as 32% by weight sodium hydroxide solution 30 from the chloralkali electrolysis 14. An additional amount of 4.13 t/h of NaOH with 17.84 t/h of H₂O is obtained from external sources and supplied.

814.76 t/h of water are supplied to the polycarbonate synthesis (2) and employed as washing water.

The resulting NaCl-containing wastewater (25) comprising an amount of 47.45 t/h of NaCl and 901.55 t/h of water is obtained as NaCl-containing wastewater. A substream thereof comprising an amount of 0.77 t/h of NaCl and 14.6 t/h of water is supplied, after purification by a stripping plant with entraining gas and an activated carbon purification, to a Cl₂ production by chloralkali electrolysis (14). This covers the water demand of the electrolysis, thus obviating the need for addition of water to the chloralkali electrolysis. This conserves water resources. The obtained polycarbonate (24) is used for preparing polycarbonate material (37).

After use of the polycarbonate material in various commercial applications (80), said material may be collected and recycled (90) to supply the resulting polycarbonate material waste (38) to an incineration (10b). Incineration is preferably effected with oxygen (27) from a water electrolysis (5), thus forming a highly concentrated CO₂ offgas stream (31). This CO₂ stream (31) is supplied to a CO₂ purification (4) in which the water originating from incineration is removed and nitrogen oxides and sulfur oxides are separated. 17.84 t/h of CO₂ are subsequently provided and supplied to the RWGS (6).

The RWGS reaction is operated at 802° C., wherein to maintain the reaction temperature bio-natural gas (28) is introduced and burnt.

The process according to the invention makes it possible to substitute 6.25% of the carbon present in the PC from a non-fossil carbon source. The use of renewable energy in the chloralkali electrolysis further reduces the CO₂ footprint of the phosgene produced from CO and Cl₂, thus allowing for a sustainably produced PC.

1. A process for producing polycarbonate, comprising at least the steps of:
producing at least chlorine and hydrogen by chloralkali electrolysis of alkali metal chloride in aqueous solution,
providing a purified carbon dioxide gas stream produced by a method containing at least the steps of:
providing a carbon dioxide gas stream,
purifying the carbon dioxide gas stream of secondary constituents to obtain the purified carbon dioxide gas stream,
introducing hydrogen together with the purified carbon dioxide gas stream into a reverse water gas shift (RWGS) reaction zone to form a reaction mixture and reacting the reaction mixture according to the principle of RWGS to afford a product gas mixture containing unconverted reactant, steam, carbon monoxide and optionally byproducts,
separating water of the steam from the product gas mixture to produce a first gas mixture,
separating unconverted carbon dioxide from the first gas mixture of the RWGS reaction obtained from the separation to produce a second gas mixture and recycling the unconverted carbon dioxide into the RWGS reaction,
separating unconverted hydrogen from the second gas mixture , and recycling the separated unconverted hydrogen into the RWGS reaction,
introducing carbon monoxide from the second gas mixture into a phosgene synthesis,
supplying the chlorine formed by the chloralkali electrolysis into the phosgene synthesis,
synthesizing phosgene from the carbon monoxide and the chlorine of the phosgene synthesis, and
reacting at least the phosgene with at least one diol to afford at least one polycarbonate.

2. The process as claimed in claim 1, wherein the RWGS synthesis employs purified carbon dioxide which is provided from a recovery of polycarbonate material waste by incineration and/or by pyrolysis as carbon dioxide and is purified in the purification.

3. The process as claimed in claim 2, wherein the recovery of polycarbonate material waste comprises performing an incineration using gas having an oxygen gas content of at least 30% by volume.

4. The process as claimed in claim 2, wherein the gas has an oxygen gas content of at least 50% by volume.

5. The process as claimed in either of claim 3, wherein the recovery of polycarbonate material waste comprises performing a water electrolysis using electricity generated from renewable energy.

6. The process as claimed in claim 1, wherein the chloralkali electrolysis is performed using electricity from feedback energy obtained during an incineration of polycarbonate material waste and/or the performing of the RWGS reaction.

7. The process as claimed in claim 1, wherein the RWGS reaction is supplied with heat energy produced by means of electricity generated from renewable energy.

8. The process as claimed in claim 1, wherein the supplying of heat energy to the RWGS reaction is performed using feedback energy obtained from an incineration of polycarbonate material waste.

9. The process as claimed in claim 1, wherein the RWGS reaction is supplied with heat energy effected by burning of hydrocarbons from renewable sources.

10. The process as claimed in claim 1, wherein the carbon dioxide gas stream to be purified comprises carbon dioxide produced by an incineration of polycarbonate material waste, wherein the polycarbonate material waste is recycled polycarbonate material.

11. The process as claimed in claim 1, wherein in the reaction of at least phosgene with at least one diol, at least one polycarbonate and an alkali metal chloride in solution is formed and this solution is subjected to a separation and purification to produce a separated and purified alkali metal chloride in aqueous solution, wherein said separated and purified alkali metal chloride present in aqueous solution is supplied to the chloralkali electrolysis.

12. The process as claimed in claim 1, wherein the chloralkali electrolysis is performed using electricity generated from renewable energy.

13. The process as claimed in claim 1, wherein the reaction of at least phosgene with at least one diol to afford at least one polycarbonate is additionally supplied with alkali metal hydroxide solution.

14. An apparatus system for producing polycarbonate comprising:
at least one electrolyser for chloralkali electrolysis, the at least one electrolyser comprising at least one inlet for an aqueous solution of alkali metal chloride, at least one outlet for chlorine and at least one outlet for hydrogen;
at least one reverse water gas shift (RWGS) reactor containing at least one RWGS reaction zone, at least one heating element as an apparatus for supplying heat energy to the RWGS reaction zone and at least one inlet for introducing carbon dioxide and hydrogen into the RWGS reaction zone and at least one outlet for carbon monoxide-containing product gas from the RWGS reactor, wherein:
(i) at least one inlet for introducing hydrogen into the RWGS reaction zone is in fluid connection with at least one outlet for hydrogen of the at least one electrolyzer for the chloralkali electrolysis;
(ii) at least one inlet for introducing carbon dioxide into the RWGS reaction zone is in fluid connection with at least one supplying source of a purified CO₂ gas stream which has been produced by at least the steps of:
a) providing a carbon dioxide gas stream, and
b) purifying the carbon dioxide gas stream of secondary components ; and
(iii) at least one outlet for the carbon monoxide-containing product gas from the RWGS reactor is in fluid connection with a water separation;
at least one apparatus for separating water which comprises at least one inlet which is in fluid connection with the outlet for the carbon monoxide-containing product gas from the RWGS reactor and at least one outlet for the separated water and at least one outlet for a dried carbon monoxide-containing product gas;
at least one apparatus for separating carbon dioxide which comprises at least one inlet which is in fluid connection with the outlet for the dried carbon monoxide-containing product gas from the apparatus for separating water and at least one outlet for the separated carbon dioxide which is in fluid connection with at least one inlet for carbon dioxide of the RWGS reactor, and at least one outlet for prepurified, carbon monoxide-containing product gas;
at least one apparatus for separating H₂—CO containing at least one inlet which is in fluid communication with the outlet for the prepurified, carbon monoxide-containing product gas from the apparatus for separating carbon dioxide, at least one outlet for the carbon monoxide and at least one outlet for the residual gas from the H₂—CO separation;
at least one apparatus for producing phosgene which comprises at least one inlet for carbon monoxide which is in fluid connection with the outlet of the apparatus for separation of H₂—CO provided for the carbon monoxide, and contains at least one outlet for phosgene and at least one outlet for chlorine, wherein at least one inlet for chlorine is in fluid connection with at least one outlet for chlorine of said electrolyzer;
at least one apparatus for producing polycarbonate containing at least one inlet for diol, at least one outlet for polycarbonate and at least one inlet for phosgene which is in fluid connection with at least one outlet for phosgene of the apparatus for producing phosgene.

15. A method comprising producing polycarbonate with a provided carbon monoxide produced according to a process containing the steps of:
providing a purified CO₂ gas stream produced by a method containing at least the steps of:
providing a carbon dioxide gas stream,
purifying the carbon dioxide gas stream of secondary components to obtain a gas stream of purified carbon dioxide,
introducing hydrogen together with the purified carbon dioxide gas stream into a reverse water gas shift (RWGS) reaction zone and reaction of the reactants according to the principle of RWGS to afford a product gas mixture containing unconverted reactant, steam, carbon monoxide and optionally byproducts,
separating the water of the steam from the product gas mixture to produce a first gas mixture,
separating unreacted carbon dioxide from the first gas mixture of the RWGS reaction obtained from the separation to produce a second gas mixture, and recycling the unreacted carbon dioxide to the RWGS reaction,
separating hydrogen unconverted in the RWGS reaction from the second gas mixture of carbon monoxide and hydrogen obtained after the separation and recycling the separated hydrogen into the RWGS reaction,
wherein the method comprises:
producing at least chlorine and hydrogen by chloralkali electrolysis of alkali metal chloride in aqueous solution,
introducing the provided carbon monoxide into a phosgene synthesis,
supplying the previously formed chlorine into the phosgene synthesis,
synthesizing phosgene from carbon monoxide and chlorine, and
reacting at least phosgene with at least one diol to afford at least one polycarbonate.

16. The process as claimed in claim 1, wherein the alkali metal is sodium chloride.

17. The process as claimed in claim 1, wherein the secondary constituents comprise nitrogen oxides, sulfur compounds, dust, water, oxygen and HCl.

18. The process as claimed in claim 1, wherein the product gas mixture comprises methane as a byproduct.

19. The process as claimed in claim 1, wherein the unconverted carbon dioxide is separated from the first gas mixture by amine scrubbing.

20. The process as claimed in claim 1, wherein purifying the carbon dioxide gas stream of secondary constituents comprises adsorption, gas scrubbing or catalytic treatment.
